(19) United States
(12) Patent Application Publication
(10) Pub. No.: US 2004/0076758 A1
(43) Pub. Date: Apr. 22, 2004

(54) Aqueous, physically curable polyurethane-based coating materials for use as a wash primer for coatings

(76) Inventors: Bernhard Lettmann, Drensteifurt (DE); Andreas Dopp, Senden (DE); Michael Grabbe, Senden (DE); Henrik Ravn, Kolding (DK)

Correspondence Address: BASF CORPORATION, ANNE GERRY SABOURIN, 26701 TELEGRAPH ROAD, SOUTHFIELD, MI, 48034-2442, US

(21) Appl. No.: 10/432,070

(22) PCT Filed: Nov. 30, 2001
(86) PCT No.: PCT/EP01/14020

(30) Foreign Application Priority Data
Dec. 1, 2000 (DE) 100 59 886.2

(51) Int. Cl. B05D 1/36

(52) U.S. Cl. 427/407.1

(57) ABSTRACT

The use of aqueous, physically curable, pseudoplastic or thixotropic, polyurethane-based coating materials as adhesion primers for coatings, and a process for coating uncoated plastics surfaces and old coatings by applying at least one coating material to the uncoated plastics surfaces or the old coatings and curing the resulting coating film(s), which comprises applying an aqueous, physically curable, pseudoplastic or thixotropic, polyurethane-based adhesion primer to the uncoated plastics surfaces or the old coatings and overcoating it with at least one further coating material.

The present invention relates to the use of aqueous, physically curable, polyurethane based coating materials as adhesion primers for coatings. The present invention further relates to a novel process for coating uncoated plastics surfaces and for coating old coatings.

Commercial vehicles, such as buses, trucks, diggers or tractors, or automobiles, especially taxis, are fairly often recoated in whole or in part, especially if the commercial vehicles have changed ownership. In general, the old coatings are overcoated with a new coating. For the new coatings to adhere firmly to the substrate, it is often necessary to sand the old coatings, which especially with large commercial vehicles is laborious and therefore expensive.

In order to avoid this laborious pretreatment of the old coatings, use is made at present of conventional adhesion primers, containing a high fraction of organic solvents. For economic and environmental reasons, users would now like to replace the conventional adhesion primers with aqueous ones. The aqueous adhesion primers known to date, however, still necessitate a pretreatment such as sanding.

Comparable problems also arise with the refinishing of commercial vehicles and automobiles. Here, there is frequently delamination of the refinish in the direct vicinity of the repaired damage site, i.e., the taper zones. This is particularly marked with small-area repairs. If the refinishes break away or come away here, clearly visible edges are produced which may even run entirely around the refinishes, which protrude beyond the original finish. In that case, owing to the visually hard transition zones, the overall effect of the refinishes is that of “stuck-on plasters”.

Comparable adhesion problems occur with the coating of uncoated plastics surfaces.

It is an object of the present invention to find aqueous, physically curable coating materials which may be used as adhesion primers, especially on uncoated plastics surfaces or old coatings, and which do not necessitate laborious pretreatment of the uncoated plastics surfaces or old coatings prior to coating.

A further object of the present invention was to find a new process for coating uncoated plastics surfaces and old coatings, using aqueous adhesion primers, which does not require pretreatment of the uncoated plastics surfaces or of the old coatings prior to coating.

Accordingly, we have found the novel use of aqueous, physically curable, polyurethane-based, pseudoplastic or thixotropic coating materials as adhesion primers for coatings.

In the text below, the novel use is referred to as “use in accordance with the invention” and the aqueous, physically curable, pseudoplastic or thixotropic adhesion primer is referred to as the “adhesion primer of the invention”.

Moreover, we have found the novel process for coating uncoated plastics surfaces and old coatings by applying at least one coating material to the uncoated plastics surfaces or the old coatings and curing the resulting coating film(s), which involves applying an adhesion primer of the invention to the uncoated plastics surfaces or the old coatings and overcoating it with at least one coating material.

In the text below, the novel process is referred to as the “process of the invention”.

Further subject matter of the invention will emerge from the description.

The adhesion primers of the invention are aqueous, physically curable, and pseudoplastic or thixotropic.

In the context of the present invention, the quality “aqueous” indicates that the adhesion primers of the invention contain minor amounts of organic solvents, if any. Minor amounts are amounts which do not destroy the aqueous nature of the adhesion primers of the invention.

In the context of the present invention, the term “physical curing” denotes the curing of a layer of a coating material by filming through loss of solvent from the coating material, with linking within the coating taking place by looping of the polymer molecules of the film-forming components or of the binders (regarding the term, cf. Römpp Lexikon Lacke and Druckfarben, Georg Thieme Verlag, Stuttgart, New York, 1998, “binders”, pages 73 and 74). Alternatively, filming takes place by way of the coalescence of binder particles (cf. Römpp, op. cit., “curing”, pages 274 and 275). Normally, no crosslinking agents are required for this purpose. If desired, the physical curing may be assisted by atmospheric oxygen, by heat, or by exposure to actinic radiation.

The quality “pseudoplastic” indicates that the viscosity of the adhesion primers of the invention is lower at relatively high shear stresses or relatively high shear rate than at low levels (cf. Römpp, op. cit., page 546, “pseudoplasticity”).

The quality of being “thixotropic” means that, at a constant shear rate, the viscosity is dependent on the duration of shearing (cf. Römpp, op. cit., page 564, “thixotropy”).

This viscosity behavior takes account firstly of the requirements of spray application and secondly of the requirements in respect of storage stability and settling stability: in the state of motion, such as when pumping the adhesion primer of the invention in circulation in the ring circuit of the coating installation and when spraying, for example, the adhesion primer of the invention adopts a state of low viscosity which ensures easy processability. Without shear stress, on the other hand, the viscosity rises and thereby ensures that the adhesion primer already present on the uncoated plastics surface or the old coating has a reduced tendency to form runs on vertical surfaces. In the same way, a result of the higher viscosity in the stationary state, such as during storage, for instance, is that sedimentation of any solid constituents present, such as pigments, is largely prevented and that any slight degree of settling of solid constituents during the storage period can be removed again by agitation.

Preferably, the adhesion primers of the invention are clear and transparent. The qualities of being “clear” and “transparent” mean that the adhesion primers of the invention are transparent without turbidity, so that in the zones covered by the adhesion primers of the invention but not overcoated the old coatings can still be seen. This properties profile is of particular importance for refinishing. The old coatings may be visible without a shift in shade. Alternatively, the adhesion primers of the invention may also have a flatting effect, if this is desired. Furthermore, they may comprise customary and known pigments and fillers in particularly finely divided, nonhiding form if the aim is to achieve a shift in shade.

The adhesion primers of the invention comprise at least one water-soluble or water-dispersible polyurethane as film-forming component or binder. In principle, all customary and known polyurethanes are suitable, provided they are soluble or dispersible in water and are physically curable. Examples of suitable polyurethanes and their aqueous dispersions are known, for example, from the patent applications EP 0 089 497 A1, EP 0 256 540 A1, EP 0 260 447 A1, EP 0 297 576 A1, WO 96/12747, EP 0 523 610 A1, EP 0 228 003 A1, EP 0 397 806 A1, EP 0 574 417 A1, EP 0 531 510 A1, EP 0 581 211 A1, EP 0 708 788 A1, EP 0 593 454 A1, DE-A-43 28 092 A1, EP 0 299 148 A1, EP 0 394 737 A1, EP 0 590 484 A1, EP 0 234 362 A1, EP 0 234 361 A1, EP 0 543 817 A1, WO 95/14721, EP 0 521 928 A1, EP 0 522 420 A1, EP 0 522 419 A1, EP 0 649 865 A1, EP 0 536 712. A1, EP 0 596 460 A1, EP 0 596 461 A1, EP 0 584 818 A1, EP 0 669 356 A1, EP 0 634 431 A1, EP 0 678 536 A1, EP 0 354 261 A1, EP 0 424 705 A1, WO 97/49745, WO 97/49747, EP 0 401 565 A1, EP 0 817 684, column 5, lines 31 to 45, DE 44 37 535 A1, page 7, line 8 to page 8 line 49, EP 0 787 195 A1, DE 40 05 961 A1, DE 41 10 520 A1, EP 0 752 455 B1, DE 198 55 455 B1, DE 199 488 121 A1, DE 198 469 171 A1, EP 0 788 523 B1 or WO 95/12626.

It is preferred to use polyurethanes preparable by reacting at least one diisocyanate with at least one polyol selected from the group consisting of saturated and/or unsaturated polyols of high molecular mass and/or low molecular mass, and compounds by means of which stabilizing (potentially) ionic and/or nonionic functional groups are introduced, to give a polyurethane prepolymer containing isocyanate groups, and then reacting the polyurethane prepolymer with a chain extender and neutralizing the resulting polyurethane.

Examples of suitable diisocyanates are isophorone diisocyanate (i.e., 5-isocyanato-1-iso-cyanatomethyl-1,3,3-trimethylcyclohexane), 5-isocyanato-1-(2-isocyanatoeth-1-yl)-1,3,3-trimethylcyclohexane, 5-isocyanato-1-yl)-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-iso-cyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, trimethylene diisocyanate, tetramethylene diisocyanate, pentamethylene diisocyanate, hexamethylene diisocyanate (HDI), ethylethylene diisocyanate, trimethylhexane diisocyanate, heptamethylene diisocyanate or diisocyanates derived from dimeric fatty acids, as sold by Henkel under the commercial designation DDI 1410 and described in the patents WO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatoprop-1-yl)cyclohexane, 1,2-, 1,4- or 1,3-bis(4-isocyanatobut-1-yl)cyclohexane or liquid bis(4-isocyanatocyclohex-1-yl)methane with a trans/trans content of up to 30% by weight, preferably 25% by weight and in particular 20% by weight, as is described in the patent applications DE 44 14 032 A1, GB 1220717 A1, DE 16 18 795 A1, and DE 17 93 785 A1, preferably bis(4-isocyanatocyclohex-1-yl)methane, isophorone diisocyanate, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane or HDI, especially bis(4-isocyanatocyclohex-1-yl)methane.

In order to introduce branching, it is also possible to use minor amounts of polyisocyanates. Examples of suitable polyisocyanates are poly-isocyanates containing isocyanurate, biuret, allophanate, iminooxadiazinedione, urethane, urea, carbodiimide and/or uretdione groups, which are prepared in a customary and known manner from the above-described diisocyanates; examples of suitable preparation processes and polyisocyanates are known, for example, from the patents CA 2,163,591 A, U.S. Pat. No. 4,419,513 A, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A, U.S. Pat. No. 5,290,902 A, EP 0 649 806 A1, DE 42 29 183 A1 and EP 0 531 820 A1.

In order to counter the risk of gelling here, it is also possible to use monoisocyanates. Examples of suitable monoisocyanates are phenyl isocyanate, cyclohexyl isocyanate, or stearyl isocyanate or vinyl isocyanate, methacryloyl isocyanate and/or 1-(1-isocyanato-1-methylethyl)-3-(1-methylethenyl)benzene (TMI® from CYTEC).

Examples of suitable polyols are saturated or olefinically unsaturated polyesterpolyols prepared by reacting

optionally sulfonated saturated and/or unsaturated polycarboxylic acids or their esterifiable derivatives, alone or together with monocarboxylic acids, and

saturated and/or unsaturated polyols, alone or together with monools.

Examples of suitable polycarboxylic acids are aromatic, aliphatic and cycloaliphatic polycarboxylic acids. It is preferred to use aromatic and/or aliphatic polycarboxylic acids.

Examples of suitable aromatic polycarboxylic acids are phthalic acid, isophthalic acid, terephthalic acid, phthalic, isophthalic or terephthalic monosulfonate, or halophthalic acids, such as tetrachlorophthalic and tetrabromophthalic acid, among which isophthalic acid is advantageous and is therefore used with preference.

Examples of suitable acyclic aliphatic or unsaturated polycarboxylic acids are oxalic acid, malonic acid, succinic acid, glutaric acid, adipic acid, pimelic acid, suberic acid, azelaic acid, sebacic acid, undecanedicarboxylic acid, dodecanedicarboxylic acid or dimeric fatty acids or maleic acid, fumaric acid or itaconic acid, among which adipic acid, glutaric acid, azelaic acid, sebacic acid, dimeric fatty acids and maleic acid are advantageous and are therefore used with preference.

Examples of suitable cycloaliphatic and cyclic unsaturated polycarboxylic acids are 1,2-cyclobutanedicarboxylic acid, 1,3-cyclobutanedicarboxylic acid, 1,2-cyclopentanedicarboxylic acid, 1,3-cyclopentanedicarboxylic acid, hexahydrophthalic acid, 1,3-cyclohexanedicarboxylic acid, 1,4-cyclohexanedicarboxylic acid, 4-methylhexahydrophthalic acid, tricyclodecanedicarboxylic acid, tetrahydrophthalic acid or 4-methyltetrahydrophthalic acid. These dicarboxylic acids may be used both in their cis form and in their trans form, and as a mixture of both forms.

Also suitable are the transesterifiable derivatives of the abovementioned polycarboxylic acids, such as their single or multiple esters with aliphatic alcohols having 1 to 4 carbon atoms or hydroxy alcohols having 1 to 4 carbon atoms, for example. Furthermore, it is also possible to use the anhydrides of the abovementioned polycarboxylic acids, where they exist.

If desired, monocarboxylic acids may be used together with the polycarboxylic acids, examples of monocarboxylic acids being benzoic acid, tert-butylbenzoic acid, lauric acid, isononanoic acid, fatty acids of naturally occurring oils, acrylic acid, methacrylic acid, ethacrylic acid and crotonic acid. As monocarboxylic acid, preference is given to the use of isononanoic acid.

Examples of suitable polyols are diols and triols, especially diols. Normally, triols are used alongside the diols in minor amounts, in order to introduce branching into the polyesterpolyols.

Examples of suitable diols are ethylene glycol, 1,2- or 1,3-propanediol, 1,2-, 1-3- or 1,4-butanediol, 1,2-, 1,3-, 1,4- or 1,5-pentanediol, 1,2-, 1,3-, 1,4-, 1,5- or 1,6-hexanediol, neopentyl hydroxypivalate, neopentyl glycol, diethylene glycol, 1,2-, 1,3- or 1,4-cyclohexanediol, 1,2-, 1,3- or 1,4-cyclohexanedimethanol, trimethylpentanediol, ethylbutylpropanediol, the positionally isomeric diethyloctanediols, 2-butyl-2-ethyl-1,3-propanediol, 2-butyl-2-methyl-1,3-propanediol, 2-phenyl-2-methyl-1,3-propanediol, 2-propyl-2-ethyl-1,3-propanediol, 2,2-di-tert-butyl-1,3-propanediol, 2-butyl-2-propyl-1,3-propanediol, 1-dihydroxymethylbicyclo [2.2.1]heptane, 2,2-diethyl-1,3-propanediol, 2,2-dipropyl-1,3-propanediol, 2-cyclohexyl-2-methyl-1,3-propanediol, 2,5-dimethyl-2,5-hexanediol, 2,5-diethyl-2,5-hexanediol, 2-ethyl-5-methyl-2,5-hexanediol, 2,4-dimethyl-2,4-pentanediol, 2,3-dimethyl-2,3-butanediol, 1,4-di(2′-hydroxypropyl)-benzene or 1,3-di(2′-hydroxypropyl)benzene.

Of these diols, 1,6-hexanediol and neopentyl glycol are particularly advantageous and are therefore used with particular preference.

The abovementioned dials may also be used per se for the preparation of the polyurethanes for use in accordance with the invention.

Examples of suitable triols are trimethylolethane, trimethylolpropane and glycerol, especially trimethylolpropane.

The abovementioned triols may also be used per se for the preparation of the polyurethanes for use in accordance with the invention, in particular as chain extenders (cf. patent EP 0 339 433 A1).

If desired, minor amounts of monools may also be used. Examples of suitable monools are alcohols or phenols such as ethanol, propanol, n-butanol, secbutanol, tert-butanol, amyl alcohols, hexanols, fatty alcohols, allyl alcohol or phenol.

The polyesterpolyols may be prepared in the presence of small amounts of an appropriate solvent as entrainer. Entrainers used are, for example, aromatic hydrocarbons, such as especially xylene and (cyclo)aliphatic hydrocarbons, such as cyclohexane or methylcyclohexane, for example.

Further examples of suitable polyols are polyesterdiols obtained by reacting a lactone with a diol. They are notable for the presence of terminal hydroxyl groups and repeating polyester units of the formula —(—CO—(CHR)ₘ—CH₂—O—)—. In this formula, the index m is preferably from 4 to 6 and the substituent R is hydrogen or an alkyl, cycloalkyl or alkoxy radical. No substituent contains more than 12 carbon atoms. The total number of carbon atoms in the substituent does not exceed 12 per lactone ring. Examples of such compounds are hydroxycaproic acid, hydroxybutyric acid, hydroxydecanoic acid, and/or hydroxystearic acid.

For the preparation of the polyesterdiols, preference is given to the unsubstituted ε-caprolactone, in which m has the value 4 and all substituents R are hydrogen. The reaction with lactone is started by low molecular mass polyols such as ethylene glycol, 1,3-propanediol, 1,4-butanediol or dimethylolcyclohexane. It is, however, also possible to react other reaction components, such as ethylenediamine, alkyldialkanolamines or else urea, with caprolactone. Also suitable as diols of relatively high molecular mass are polylactamdiols, which are prepared by reacting, for example, c-caprolactam with diols of low molecular mass.

Further examples of suitable polyols are polyetherpolyols, especially those having a number average molecular weight of from 400 to 5000, in particular from 400 to 3000. Examples of highly suitable polyetherdiols are polyetherdiols of the general formula H—(—O—(CHR¹)ₒ—)ₚOH, where the substituent R¹ is hydrogen or a lower, substituted or unsubstituted alkyl radical, the index o is from 2 to 6, preferably 3 or 4, and the index p is from 2 to 100, preferably from 5 to 50. Particularly suitable examples are linear or branched polyetherdiols such as poly(oxyethylene) glycols, poly(oxypropylene) glycols and poly(oxybutylene) glycols.

The polyetherdiols should firstly not introduce excessive amounts of ether groups, since otherwise the polyurethanes that are formed, for use in accordance with the invention, swell in water. Secondly, they may be used in amounts which ensure the nonionic stabilization of the polyurethanes. In that case, they act as the functional nonionic groups (a3) described below.

Further examples of suitable polyols are poly(meth)acrylatediols, polycarbonatediols or polyolefinpolyols such as POLYTAIL® from Mitsubishi Chemical Group.

The polyurethane used in accordance with the invention contains either

(a1) functional groups which can be converted into cations by neutralizing agents and/or quaternizing agents, and/or cationic groups, especially ammonium groups, or

(a2) functional groups which can be converted into anions by neutralizing agents, and/or anionic groups, especially carboxylic acid groups and/or carboxylate groups, and/or

(a3) nonionic hydrophilic groups, especially poly(alkylene ether) groups.

Examples of suitable functional groups (a1) for use in accordance with the invention which can be converted into cations by neutralizing agents and/or quaternizing agents are primary, secondary or tertiary amino groups, secondary sulfide groups or tertiary phosphine groups, especially tertiary amino groups or secondary sulfide groups.

Examples of suitable cationic groups (a1) for use in accordance with the invention are primary, secondary, tertiary or quaternary ammonium groups, tertiary sulfonium groups or quaternary phosphonium groups, preferably quaternary ammonium groups or tertiary sulfonium groups.

Examples of suitable functional groups (a2) for use in accordance with the invention that can be converted into anions by neutralizing agents are carboxylic, sulfonic or phosphonic acid groups, especially carboxylic acid groups.

Examples of suitable anionic groups (a2) for use in accordance with the invention are carboxylate, sulfonate, or phosphonate groups, especially carboxylate groups.

Examples of suitable neutralizing agents for functional groups (a1) which can be converted into cations are organic and inorganic acids such as sulfuric acid, hydrochloric acid, phosphoric acid, formic acid, acetic acid, lactic acid, dimethylolpropionic acid or citric acid.

Examples of suitable neutralizing agents for functional groups (a2) which can be converted into anions are ammonia, ammonium salts, such as ammonium carbonate or ammonium hydrogen carbonate, for example, and also amines and amino alcohols, such as trimethylamine, triethylamine, tributylamine, dimethylaniline, diethylaniline, triphenylamine, dimethylethanolamine, diethylethanolamine, methyldiethanolamine, triethanolamine and the like, for example. Neutralization may take place in organic phase or in aqueous phase. The preferred neutralizing agent used is dimethylethanolamine.

The amount of neutralizing agent used overall in the coating composition of the invention is chosen so that from 1 to 100 equivalents, preferably from 50 to 90 equivalents, of the functional groups (a1) or (a2) of the polyurethane (A) for use in accordance with the invention are neutralized.

Of these functional (potentially) ionic groups (a1) and (a2) and functional nonionic groups (a3), the (potentially) anionic groups (a2) are advantageous and are therefore used with particular preference.

(Potentially) anionic groups (a2) are introduced into the polyurethane molecules by way of the incorporation of compounds containing in the molecule at least one group which is reactive toward isocyanate groups and one group which is capable of forming anions. The amount to be used may be calculated from the target acid number.

Examples of suitable such compounds are those containing two isocyanate-reactive groups in the molecule. Suitable isocyanate-reactive groups are, in particular, hydroxyl groups, and also primary and/or secondary amino groups. Accordingly, it is possible to use, for example, alkanoic acids having two substituents on the a carbon atom. The substituent may be a hydroxyl group, an alkyl group or, preferably, an alkylol group. These alkanoic acids have at least one, generally 1 to 3 carboxylic groups in the molecule. They have 2 to about 25, preferably 3 to 10 carbon atoms. Examples of suitable alkanoic acids are dihydroxypropionic acid, dihydroxysuccinic acid and dihydroxybenzoic acid. A particularly preferred group of alkanoic acids are the α,α-dimethylolalkanoic acids of the general formula R²-C(CH₂OH)₂COOH, in which R² is a hydrogen atom or an alkyl group of up to about 20 carbon atoms. Examples of especially suitable alkanoic acids are 2,2-dimethylolacetic acid, 2,2-dimethylolpropionic acid, 2,2-dimethylolbutyric acid and 2,2-dimethylolpentanoic acid. The preferred dihydroxyalkanoic acid is 2,2-dimethylolpropionic acid. Examples of compounds containing amino groups are α,β-diaminovaleric acid, 3,4-diaminobenzoic acid, 2,4-diaminotoluenesulfonic acid and 2,4-diaminodiphenyl ether sulfonic acid.

Nonionic stabilizing poly(oxyalkylene) groups (a3) may be introduced as lateral or terminal groups into the polyurethane molecules. For this purpose it is possible, for example, to use alkoxypoly(oxyalkylene) alcohols with the general formula R³O—(—CH₂—CHR⁴ —O—)ᵣH in which R³ is an alkyl radical of 1 to 6 carbon atoms, R⁴ is a hydrogen atom or an alkyl radical of 1 to 6 carbon atoms, and the index r stands for a number between 20 and 75 (cf. patents EP 0 354 261 A1 and EP 0 424 705 A2).

The use of chain extenders, such as polyols, polyamines and amino alcohols, leads to an increase in the molecular weight of polyurethanes.

Suitable polyols for the chain extension are polyols having up to 36 carbon atoms per molecule, such as ethylene glycol, diethylene glycol, triethylene glycol, 1,2-propanediol, 1,3-propanediol, 1,4-butanediol, 1,2-butylene glycol, 1,6-hexanediol, trimethylolpropane, castor oil or hydrogenated castor oil, ditrimethylolpropane ether, pentaerythritol, 1,2-cyclohexanediol, 1,4-cyclohexanedimethanol, bisphenol A, bisphenol F, neopentyl glycol, neopentyl glycol hydroxypivalate, hydroxyethylated or hydroxypropylated bisphenol A, hydrogenated bisphenol A, or mixtures thereof (cf. patents EP 0 339 433 A1, EP 0 436 941 A1 and EP 0 517 707 A1).

Examples of suitable polyamines have at least two primary and/or secondary amino groups. Polyamines are essentially alkylenepolyamines having 1 to 40 carbon atoms, preferably about 2 to 15 carbon atoms. They may carry substituents which have no hydrogen atoms that are reactive with isocyanate groups. Examples are polyamines having a linear or branched aliphatic, cycloaliphatic or aromatic structure and at least two primary amino groups.

As diamines, mention may be made of hydrazine, ethylenediamine, propylenediamine, 1,4-butylenediamine, piperazine, 1,4-cyclohexyldimethylamine, 1,6-hexamethylenediamine, trimethylhexamethylenediamine, menthanediamine, isophoronediamine, 4,4′-diaminodicyclohexylmethane and aminoethylethanolamine. Preferred diamines are hydrazine, alkyl- or cycloalkyldiamines such as propylenediamine and 1-amino-3-aminomethyl-3,5,5-trimethylcyclohexane.

It is also possible to use polyamines containing more than two amino groups per molecule. In these cases, however, it is necessary to ensure—for example, by using monoamines as well—that crosslinked polyurethane resins are not obtained. Polyamines of this kind which may be used are diethylenetriamine, triethylenetetramine, dipropylenediamine and dibutylenetriamine. An example of a monoamine is ethylhexylamine (cf. patent EP 0 089 497 A1).

Examples of suitable amino alcohols are ethanolamine and diethanolamine.

In the adhesion primers of the invention, the polyurethanes are present preferably in an amount, based on their solids, of from 60 to 99, preferably from 65 to 98.5, with particular preference from 70 to 98, with very particular preference from 75 to 97.5, and in particular from 80 to 97% by weight.

Viewed in terms of its methodology, the preparation of the polyurethanes has no special features but instead takes place as described in the prior art cited above.

For the use in accordance with the invention, the polyurethanes, as they are and/or in organic solution, are dispersed in water or an aqueous medium. By an aqueous medium is meant water containing typical paint constituents, such as organic solvents, cobinders, rheological assistants or preservatives. It is critical here that the organic solvents do not destroy the aqueous nature of the medium.

The adhesion primers of the invention comprise at least one Theological assistant.

Examples of suitable Theological assistants (thickeners) are those known from the patent applications WO 94/22968, EP 0 276 501 A1, EP 0 249 201 A1 and WO 97/12945; crosslinked polymeric microparticles, as are disclosed, for example, in EP 0 008 127 A1; inorganic phyllosilicates such as aluminum magnesium silicates, sodium magnesium silicates and sodium magnesium fluorine lithium phyllosilicates of the montmorillonite type; silicas such as Aerosils; or synthetic polymers containing ionic and/or associative groups, such as polyvinyl alcohol, poly(meth)acrylamide, poly(meth)acrylic acid, polyvinylpyrrolidone, styrene-maleic anhydride copolymers or ethylene-maleic anhydride copolymers and their derivatives, or polyacrylates; or polyurethane-based associative thickeners, as described in Römpp, op. cit., “Thickeners”, pages 599 to 600, and in the textbook “Lackadditive” [Additives for coatings] by Johan Bieleman, Wiley-VCH, Weinheim, New York, 1998, pages 51 to 59 and 65; in particular, combinations of ionic and nonionic thickeners, as described in the patent application DE 198 41 842 A1 for imparting pseudoelasticity; or the combination of associative, polyurethane-based thickeners and polyurethane-based wetting agents, as is described in detail in the German patent application DE 198 35 296 A1; or the combination of associative, polyurethane-based thickeners and inorganic phyllosilicates.

Preferably, the adhesion primer of the invention further comprises at least one organic solvent which is miscible with water.

Suitable water-miscible organic solvents are typical paint solvents which are miscible in any proportion with water, such as secondary butanol, ethylene glycol, propylene glycol, butyl glycol and methyl, ethyl or propyl ethers thereof, ketones such as acetone or diacetone alcohol, cyclic ethers such as tetrahydrofuran or dioxane, or amides such as N,N-dimethylformamide or N-methylpyrrolidone (cf. Paints Coatings and Solvents, Dieter Stoye and Werner Freitag (eds.), 2^{nd} edition, Wiley-VCH, Weinheim, New York, 1998, pages 329 and 330).

It is also possible to use at least one organic solvent which is miscible with water only to a small extent or not at all. These solvents take up preferably less than 10, more preferably less than 9, and in particular less than 8% by weight of water, based on water and solvent, at 20° C. Conversely, water at 20° C. takes up preferably less than 6, more preferably less than 5, and in particular less than 4% by weight, based on water and solvent. Examples of suitable organic solvents miscible with water to a smaller extent or not at all are ketones such as methyl isobutyl ketone, diisobutyl ketone, cyclohexanone or trimethylcyclohexanone, ethers such as dibutyl ether, esters such as isopropyl acetate, butyl acetate, ethyl glycol acetate or butyl glycol acetate, or higher alcohols such as hexanol, cyclohexanol, trimethylcyclohexanol or 2-ethyl-1-hexanol (isooctanol) (cf. Paints Coatings and Solvents, Dieter Stoye and Werner Freitag (eds.), 2^{nd} edition, Wiley-VCH, Weinheim, New York, 1998, pages 329 and 330).

Moreover, the adhesion primers of the invention may comprise at least one preservative. In the context of the present invention, preservatives mean biocides. Examples of suitable biocides are active in-can preservative or film preservative compounds, especially in-can preservative compounds, as described in detail, for example, in the abovementioned textbook “Lackadditive” by Johan Bieleman, pages 325 to 3,45. Preference is given to using formaldehyde donors (cf. op. cit. pages 333 and 334).

Additionally, the adhesion primers of the invention may comprise at least one customary and known wetting agent. Examples of suitable wetting agents are siloxanes, fluorine compounds, carboxylic monoesters, phosphoric esters, polyacrylic acids and their copolymers, and polyurethanes.

The adhesion primers of the invention may not least further comprise at least one customary and known cobinder. Examples of suitable cobinders are polyalkylene ethers such as poly(oxyethylene), poly(oxypropylene) or poly(oxyethylene-co-oxypropylene) ethers, or oligotetrahydrofuran. Cobinders of this kind are sold, for example, by BASF AG under the brandname Pluriol®.

Furthermore, the adhesion primer of the invention may comprise additives such as hiding and nonhiding pigments, nanoparticles, UV absorbers, light stabilizers, free-radical scavengers, defoamers, emulsifiers, adhesion promoters, leveling agents, film-forming auxiliaries, flame retardants, antiskinning agents, corrosion inhibitors, waxes and/or flatting agents.

A particularly advantageous adhesion primer is preparable by mixing

(A) an aqueous dispersion of at least one of the above-described, water-soluble or water-dispersible polyurethanes with

(B) an aqueous dispersion comprising

(b1) at least one of the above-described polyurethanes,

(b2) at least one of the above-described Theological assistants, and

(b3) at least one of the above-described organic solvents, and also, if desired,

(b4) at least one of the above-described preservatives.

The polyurethanes present in the dispersions (A) and (B) may be the same or different.

The adhesion primers of the invention preferably have a solids content of from 5 to 25, more preferably from 5 to 24, with particular preference from 6 to 23, with very particular preference from 7 to 22, and in particular from 10 to 20% by weight.

Their VOC (volatile organic compounds) level is preferably from 240 to 720, in particular from 300 to 480 g/l (from 2 to 6, in particular from 2.5 to 4 lbs/gal).

The dispersions (A) and (B) or the adhesion primer of the invention may be prepared by any of the methods which are known and customary in the coatings field. For example, the starting products described above may be placed together individually in succession or all at once in an appropriate mixing unit, such as a stirred vessel, dissolver or Ultraturrax, and mixed with one another.

The adhesion primers of the invention are used in processes for coating uncoated plastics surfaces. For this purpose they are applied to the untreated uncoated plastics surfaces and then overcoated with the coating. The dry film thickness of the adhesion primer of the invention may vary widely in this application. It is preferably from 5 to 50, more preferably from 6 to 45, with particular preference from 7 to 40, with very particular preference from 8 to 35, and in particular from 9 to 30 μm.

The adhesion primers of the invention are used in processes for coating uncoated, untreated plastics surfaces. For this purpose, they are applied to the plastics and then overcoated with the coating.

Examples of suitable plastics are ABS, AMMA, ASA, CA, CAB, EP, UF, CF, MF, MPF, PF, PAN, PA, PE, HDPE, LDPE, LLDPE, UHMWPE, PC, PC/PBT, PC/PA, PET, PMMA, PP, PS, SB, PUR, PVC, RF, SAN, PBT, PPE, POM, PUR-RIM, SMC, BMC, PP-EPDM and UP (abbreviations in accordance with DIN 7728T1).

Furthermore, the adhesion primers of the invention are used as part of the processes for the recoating of old coatings. For this purpose they are applied to the untreated old coatings and then overcoated with the new coating. The old coatings are coated with the adhesion primers of the invention over the entire area to be recoated. The old coatings may be present on any of the very wide variety of substrates. Suitable substrates comprise metals, plastics, wood, ceramic, stone, textile, fiber composites, leather, glass, glass fibers, glass wool, rock wool, minera-land resin-bound building materials, such as plasterboards and cement slabs or roofing tiles, and also composites of these materials. Accordingly, the old coatings and the new coatings may be used to coat commercial vehicles and automobiles, the interior and exterior of constructions, furniture, doors and windows, coils, containers, electrical components, and other appliances and components of everyday use, including industrial use. Preferably, the old coatings to be recoated comprise the original finishes of commercial vehicles and automobiles.

Furthermore, the adhesion primers of the invention are used as part of processes for refinishing in the technological fields referred to above, but especially for the refinishing of commercial vehicle and automobile original finishes. For this purpose they are applied to the filled damage site and its immediate vicinity, i.e., the taper zones. They are subsequently overcoated with the refinish.

The old coatings to be recoated or repaired may have been prepared from any of a wide variety of coating materials. They may comprise solid-color and/or effect topcoats or multicoat systems comprising at least one basecoat and at least one clearcoat.

Examples of solid-color and/or effect topcoats and basecoats are given in the patent applications referred to above in connection with the preparation of polyurethanes.

Suitable clearcoat materials are one-component or multicomponent clearcoat materials, powder clearcoat materials, powder slurry clearcoat materials, UV curable clearcoat materials or sealers, as are known from the patent applications, patents and publications DE 42 04 518 A1, EP 0 594 068 A1, EP 0 594 071 A1, EP 0 594 142 A1, EP 0 604 992 A1, EP 0 596 460 A1, WO 94/10211, WO 94/10212, WO 94/10213, WO 94/22969 or WO 92/22615, U.S. Pat. No. 5,474,811 A1, U.S. Pat. No. 5,356,669 A1 or U.S. Pat. No. 5,605,965 A1, DE 42 22 194 A1, the product information bulletin from BASF Lacke+Farben AG, “Pulverlacke” [powercoatings], 1990, the BASF Coatings AG brochure “Pulverlacke, Pulverlacke fur industrielle Anwendungen” [powder coating materials, powder coatings for industrial applications], January 2000, U.S. Pat. No. 4,268,542 A1, DE 195 40 977 A1, DE 195 18 392 A1, DE 196 17 086 A1, DE-A-196 13 547, DE 196 52 813 A1, DE-A-198 14 471 A1, EP 0 928 800 A1, EP 0 636 669 A1, EP 0 410 242 A1, EP 0 783 534 A1, EP 0 650 978 A1, EP 0 650 979 A1, EP 0 650 985 A1, EP 0 540 884 A1, EP 0 568 967 A1, EP 0 054 505 A1, EP 0 002 866 A1, DE 197 09 467 A1, DE 42 03 278 A1, DE 33 16 593 A1, DE 38 36 370 A1, DE 24 36 186 A1, DE 20 03 579 B1, WO 97/46549, WO 99/14254, us 5,824,373 A1, U.S. Pat. No. 4,675,234 A1, U.S. Pat. No. 4,634,602 A1, U.S. Pat. No. 4,424,252 A1, U.S. Pat. No. 4,208,313 A1, U.S. Pat. No. 4,163,810 A1, U.S. Pat. No. 4,129,488 A1, U.S. Pat. No. 4,064,161 A1, U.S. Pat. No. 3,974,303 A1, EP 0 844 286 A1, DE 43 03 570 A1, DE 34 07 087 A1, DE 40 11 045 A1, DE 40 25 215 A1, DE 38 28 098 A1, DE 40 20 316 A1 and DE 41 22 743 A1.

For the coating of unpretreated plastics surfaces, recoating of old coatings, and refinishing, it is possible to use the above-described solid-color topcoat materials, aqueous basecoat materials, and clearcoat materials. It is preferred to use coating materials as are commonly employed for the refinishing or for the coating of thermally sensitive substrates.

The basecoat materials are commercially customary products, which are sold, for example, by BASF Coatings AG under the brandnames Glasurit® 55 Line with Glasurit® adjustment additive 352-91 or Glasurit® 90 Line with Glasurit® adjustment additive 93-E 3 and Glasurit® blending base 90-M5 in accordance with the European patent application EP 0 578 645 A1.

Clearcoat materials which may be used include all customary and known two-component clearcoat materials based on commercially customary, hydroxyl-containing binders, such as Glasurit® Racing Clear 923-144 and polyisocyanates such as Glasurit® MS curing agent 929-71 (both from BASF Coatings AG).

The coating materials, i.e., the adhesion primers of the invention and the further coating materials, may be applied by any customary application method, such as by spraying, knife coating, brushing, flow coating, dipping, impregnating, trickling or rolling, for example. The substrate to be coated may itself be at rest, with the application equipment or unit being moved. Alternatively, the substrate to be coated, in particular a coil, may be in motion, with the application unit being at rest relative to the substrate or being moved appropriately.

It is preferred to employ spray application methods, such as compressed air spraying, airless spraying, high-speed rotation, electrostatic spray application (ESTA), for example, alone or in conjunction with hot spray application such as hot air spraying, for example. Preference is given to the use of HVLP guns. The application may be carried out at temperatures of max. 70 to 80° C., so that appropriate application viscosities are achieved without any change or damage to the coating materials and their overspray (which may be intended for reprocessing) during the short period of thermal stress. For instance, hot spraying may be configured in such a way that the coating material is heated only very briefly in the spray nozzle or shortly before the spray nozzle.

The spray booth used for application may, for example, be operated with a circulation system, which may be temperature-controllable, and which is operated with an appropriate absorption medium for the overspray, an example of such medium being the particular coating material being applied.

The curing of the applied coating materials likewise has no special features but instead takes place using customary and known apparatus such as heat emitters which use near or far infrared light, heated blowers or forced air ovens. If desired, the thermal curing may be assisted or supplemented by actinic radiation, especially UV radiation. Curing with UV radiation is carried out using the customary and known radiation sources and optical auxiliary measures. Examples of suitable radiation sources are high or low pressure mercury vapor lamps, with or without lead doping in order to open up a radiation window of up to 405 nm, or electron beam sources. Further examples of suitable radiation sources are described in the German patent application DE 198 18 735 A1, column 10 lines 31 to 61.

It is a very particular advantage of the adhesion primers of the invention that they adhere especially firmly to a very wide variety of old coatings and uncoated plastics surfaces over the long term while at the same time exhibiting excellent longterm adhesion to the new coatings and the refinishes. A particular feature is that the plastics surfaces and the old coatings do not require pretreatment in order for the adhesion to be very good. Accordingly, the use in accordance with the invention in the above-mentioned processes makes it possible to obtain considerable savings in time, materials, and costs.

### EXAMPLES

### Preparation Example 1

The preparation of a Polyurethane Dispersion

A suitable reaction vessel equipped with stirrer, reflux condenser and a feed vessel was charged under inert gas with 130.8 parts by weight of a polyester having a number average molecular weight of 1400 daltons, based on a commercially customary unsaturated dimeric fatty acid (iodine number: 10 mg I₂/g, monomer content: not more than 0.1% by weight, trimer content: not more than 2% by weight, acid number: 195 to 200 mg KOH/g, and saponification number: 197 to 202 mg KOH/g), isophthalic acid and hexanediol, and, in succession, 11.7 parts by weight of dimethylolpropionic acid, 2.4 parts by weight of neopentyl glycol, 103.4 parts by weight of methyl ethyl ketone and 63.1 parts by weight of di(4-isocyanatocyclohex-1-yl)methane were added. The resulting reaction mixture was held under reflux until the isocyanate content was constant. Subsequently, 6.1 parts by weight of trimethylolpropane were added to the reaction mixture, and it was held under reflux until the viscosity was 12 dPas (product diluted 50% in N-methylpyrrolidone). Any excess isocyanate still present was blocked by adding 3.4 parts by weight of n-butanol. Thereafter, in succession, 6.1 parts by weight of dimethylethanolamine, 42.8 parts by weight of a polypropylene glycol having a number average molecular weight of 900 daltons (Pluriol® P 900) and 533.7 parts by weight of deionized water were added to the reaction mixture. Following the removal of the methyl ethyl ketone under reduced pressure, a polyurethane dispersion was obtained which was adjusted to a solids content of 30% by weight using deionized Water. The pH of the dispersion was 7.7.

### Preparation Example 2

The Preparation of a Solution of a Water Dispersible Polyurethane

A suitable reaction vessel equipped with stirrer, reflux condenser and a feed vessel was charged under inert gas with 214.7 parts by weight of a polyester having a number average molecular weight of 1400 daltons, based on a commercially customary unsaturated dimeric fatty acid (iodine number: 10 mg 12/9, monomer content: not more than 0.1% by weight, trimer content: not more than 2% by weight, acid number: 195 to 200 mg KOH/g, and saponification number: 197 to 202 mg KOH/g), isophthalic acid and hexanediol, and, in succession, 19.2 parts by weight of dimethylolpropionic acid, 4.0 parts by weight of neopentyl glycol, 169.7 parts by weight of methyl ethyl ketone and 103.6 parts by weight of di(4-isocyanatocyclohex-1-yl)methane were added. The resulting reaction mixture was held under reflux until the isocyanate content was constant. Subsequently, 10.0 parts by weight of trimethylolpropane were added to the reaction mixture, and it was held under reflux until the viscosity was 10 dPas (product diluted 50% in N-methylpyrrolidone). Thereafter, 452.4 parts by weight of butyl glycol were added. Following the removal of the methyl ethyl ketone under reduced pressure, the solution was neutralized with 11.7 parts by weight of dimethylethanolamine and adjusted to a solids content of 44% by weight using butyl glycol.

### Example 1

The Preparation of an Inventive Adhesion Primer 1

To prepare the inventive adhesion primer 1, a dispersion of 31.5 parts by weight of deionized water, 0.2 part by weight of a preservative (formaldehyde donor), 24.3 parts by weight of a magnesium phyllosilicate solution (3% by weight Laponite® RD, 3% by weight Pluriol® P 900 in deionized water), 10.7 parts by weight of the polyurethane solution of Preparation Example 2, 0.2 part by weight of a commercial, polyurethane-based rheological assistant (Acrysol® RM-8 from Rohm and Haas), 1.4 parts by weight of a commercial wetting agent solution (Tensid S, 50% strength in butyl glycol) and 2.8 parts by weight of secondary butanol was added with stirring to 28.9 parts by weight of the polyurethane dispersion of Preparation Example 1.

The mixture was subsequently adjusted to a viscosity of from 18 to 22 seconds DIN4 cup using deionized water. The inventive adhesion primer 1 had a solids content of 15% by weight and a VOC of 384 g/l (3.2 lbs/gal).

### Example 2

The Preparation of an Inventive Adhesion Primer 2

To prepare the inventive adhesion primer 2, 28.5 parts by weight of deionized water, 0.2 part by weight of the preservative, 17.0 parts by weight of the polyurethane solution from Preparation Example 2, 0.6 part by weight of the polyurethane-based Theological assistant, 1.5 parts by weight of the wetting agent solution and 4.7 parts by weight of secondary butanol were added with stirring to 47.5 parts by weight of polyurethane dispersion from Preparation Example 1.

Before processing, the resulting mixture was adjusted to spray viscosity in a volume ratio of 2:1 with a magnesium phyllosilicate solution comprising 1.5% by weight Laponites RD, 1.0% by weight Pluriol® P 900, 0.2% by weight of the preservative and 97.3% by weight deionized water.

The inventive adhesion primer 2 had a solids content of 15% by weight and a VOC figure of 384 g/l (3.2 lbs/gal).

### Examples 3 and 4

The Production of New Coatings on Old Coatings

The adhesion primers of Examples 1 and 2 were applied to unsanded, customary and known automotive original finishes, consisting of electrocoat, primer surfacer coat, basecoat and clearcoat, in one spray pass using a Sata NR95 HVLP gun (1.3 mm, internal nozzle pressure 0.7 bar). After brief flashing off at room temperature, the adhesion primers 1 and 2 were overcoated with a commercial aqueous basecoat material from BASF Coatings AG and with a commercial two-component clearcoat material from BASF Coatings AG. After curing, the new coatings on the adhesion primer coats 1 and 2 had an adhesion which was just as good as on the adhesion primer coats which had been produced from conventional adhesion primers.

What is claimed is:

1. The use of aqueous, physically curable, pseudoplastic or thixotropic, polyurethane-based coating materials as adhesion primers for coatings.

2. The use as claimed in claim 1, wherein the aqueous, physically curable, pseudoplastic or thixotropic coating materials are used as adhesion primers on uncoated plastics surfaces or old coatings.

3. The use as claimed in claim 1 or 2, wherein the uncoated plastics surfaces or the old coatings have not been pretreated.

4. The use as claimed in any of claims 1 to 3, wherein the old coatings comprise those of commercial vehicles and automobiles.

5. The use as claimed in any of claims 1 to 4, wherein the adhesion primers are clear and transparent.

6. A process for coating uncoated plastics surfaces and old coatings by applying at least one coating material to the uncoated plastics surfaces or the old coatings and curing the resulting coating film(s), which comprises applying an aqueous, physically curable, pseudoplastic or thixotropic, polyurethane-based adhesion primer to the uncoated plastics surfaces or the old coatings and overcoating it with at least one further coating material.

7. The process as claimed in claim 6, wherein the uncoated plastics surfaces and the old coatings are not pretreated prior to the application of the aqueous, clear, physically curable, pseudoplastic or thixotropic, polyurethane-based adhesion primer.

8. The process as claimed in claim 6 or 7, wherein the old coatings comprise the original finishes, intended for repair or recoating, of commercial vehicles and automobiles.

9. The process as claimed in claim 8, wherein the old coating (i) in the case of refinishing is coated in the direct vicinity of the damage site (taper zones), and (ii) in the case of recoating is coated over the entire area to be recoated, with the aqueous, clear, physically curable, pseudoplastic or thixotropic, polyurethane-based adhesion primer.

10. The process as claimed in any of claims 6 to 9, wherein the aqueous, physically curable, pseudoplastic, polyurethane-based adhesion primer is preparable by mixing
(A) an aqueous dispersion of at least one water-soluble or water-dispersible polyurethane with
(B) an aqueous dispersion comprising
(b1) at least one polyurethane,
(b2) at least one rheological assistant, and
(b3) at least one organic solvent.

11. The process as claimed in claim 10, wherein dispersion (B) comprises at least one preservative (b4).

12. The process as claimed in claim 10 or 11, wherein the dispersion (B) comprises at least two rheological assistants (b2).

13. The process as claimed in any of claims 6 to 12, wherein the polyurethanes are preparable by reacting at least one diisocyanate with at least one polyol selected from the group consisting of saturated and/or unsaturated polyols of relatively high molecular mass and/or relatively low molecular mass and compounds by means of which stabilizing (potentially) ionic and/or nonionic functional groups are introduced to give a polyurethane prepolymer containing isocyanate groups, then reacting the polyurethane prepolymer with a chain extender, and neutralizing the resulting polyurethane.

14. The process as claimed in any of claims 6 to 13, wherein the adhesion primers are clear and transparent.
